(19) United States
(12) Patent Application Publication
(10) Pub. No.: US 2013/0262640 A1
(43) Pub. Date: Oct. 3, 2013

(54) Method and Apparatus for Interconnectivity between Legacy Security Systems and Networked Multimedia Security Surveillance System

(71) Applicant: David A. Monroe, San Antonio, TX (US)

(72) Inventor: David A. Monroe, San Antonio, TX (US)

(21) Appl. No.: 13/903,024

(22) Filed: May 28, 2013

Related U.S. Application Data
(63) Continuation of application No. 09/960,126, filed on Sep. 21, 2001, now abandoned.

(51) Int. Cl. G06F 15/177

(52) U.S. Cl. CPC H04L 41/0806
USPC 709/222; 709/223

(57) ABSTRACT

Legacy devices are interfaced into a comprehensive multi-media surveillance system without requiring any modification to the legacy system. This allows a facility equipped with such systems to upgrade overall surveillance capability by overlaying the multi-function networked system over the legacy system and incorporating the legacy system directly into the more comprehensive networked system. This both enhances the functionality of the legacy system and preserves the investment made in prior art technology, while at the same time providing the user with state of the art capability for the overall system. The system provides an interface between legacy devices and a comprehensive, multi-media surveillance system. Data generated by the legacy device or legacy system is “picked-off” and transmitted to the multi-media, networked system. Any legacy device meeting minimum requirements can be interfaced to the networked system.

### BACKGROUND OF THE INVENTION

1. Field of the Invention

The subject invention is generally related to sensor, monitor and control devices generally utilized in monitoring and surveillance systems and is specifically directed to a network adaptation of legacy devices and legacy systems not intended for wide area network application.

2. Discussion of the Prior Art

Security of public facilities such as schools, banks, aircraft and airports, arenas and the like is a topic of increasing concern in recent years. Over the past few years, a number of violent incidents including bombings, shootings, arson, and hostage situations have occurred. In addition, agencies responsible for public security in these facilities must cope with more commonplace crimes, such as drug dealing, vandalism, theft and the like.

Such facilities frequently employ monitoring and surveillance systems and access control systems to enhance security. This has been common practice for a number of years. Such systems generally have a centralized monitoring console, usually attended by a guard or dispatcher. A variety of sensors are located throughout the facility, such as smoke detectors, fire detectors, motion sensors, glass breakage detectors, badge readers at various access points, and sometimes, video cameras and/or microphones. Other sensors and transducers are utilized to lock and unlock doors.

There are numerous devices utilized to collect information at remote locations and initiate a local alarm, store the information for later retrieval or forward the information to a remote location for storage and/or near real time review. Examples include fire alarms, security cameras, motion sensors, proximity switches, heat sensors, smoke and fire sensors, and the like. Almost all of these devices can be used in some form of managed network where one or more sensors may be used in combination to provide a surveillance scheme over an area to be monitored. In prior art systems, the signal generated by each type of device was used locally, or if part of a network, was sent over a dedicated network to a remote collection point for that type of device.

These prior-art devices often use technologies that is not ‘intelligent’ in the modem sense; they merely provide an ‘ON/OFF’ indication to the centralized monitoring system. The devices also are not ‘networked’ in the modern sense. Specifically, they do not communicate with one another but are generally hard-wired to the centralized monitoring system via a ‘current loop’ or similar arrangement. Such devices do not provide situational data other than their ON/OFF status.

### SUMMARY OF THE INVENTION

The subject invention is specifically directed to a system for adapting legacy, unintelligent devices to a network system in order to support such systems using an intelligent network. A typical system is shown in the copending application entitled: Multimedia Surveillance and Monitoring System Including Network Configuration, Ser. No. 09/594,041, filed on Jun. 14, 2000, and incorporated by reference herein. An example of intelligent appliances used either alone or in combination with unintelligent applications is shown in the copending application entitled: Multimedia Network Appliances for Security and Surveillance Applications (attorney docket no. 081829.000026), filed on even date herewith, and also incorporated by reference herein.

In simplest terms, the method and apparatus of the subject invention provides the means and method for connecting legacy devices to a comprehensive multi-media surveillance system without requiring any modification to the legacy system. This allows a facility equipped with such systems to upgrade its overall surveillance capability by overlaying the multi-function networked system over the legacy system and incorporating the legacy system directly into the more comprehensive networked system. This both enhances the functionality of the legacy system and preserves the investment made in prior art technology, while at the same time providing the user with state of the art capability for the overall system.

Specifically the system of the subject invention is directed to supporting an interface between legacy devices and a comprehensive, multi-media surveillance system. As used ON or OFF and generates a change-of-state signal. Typically, each time the sensor is activated, it generates a change-of-state signal that is captured in a database. The data is then periodically downloaded into a report generator. By way of example, the legacy device is typically a device for access control or for generating an alarm. However, as will be clear from the following detailed description, any legacy device meeting the minimum requirements can be interfaced to the networked system using the teachings of the subject invention.

It is an important feature of the invention that the interface is one-way. Specifically, data in its original format is sent from a legacy system or device to the network system, but no data or control functions are sent from network system to the legacy system or legacy device. Thus, the network system is non-disruptive and will not interfere with the historic or continued operation of the legacy device or system.

This permits the networked, comprehensive, multi-media surveillance system to display data collected from the legacy system through the interface. The display may be static or interactive, depending on the structure of the data. It also permits the networked system to react to the data.

As stated, any prior-art or legacy device meeting minimum requirements may be incorporated in the networked system in this manner. Specifically, in order to interface with the networked system the legacy device must have one of the following two features.

1. A data output to a serial printer or other serial device.

2. A database, stored on a computer, for which there is an ODBC (Open Data Base Connectivity) driver.

Data is captured from the legacy system devices in one of two ways:

1. Capturing data using a serial out—The data is captured by a PC having two serial ports and an Ethernet connection. The serial output from the legacy component is connected to one serial port, the legacy printer or other serial legacy output device is connected to the other serial port, and a network is to the Ethernet connector. When data is sent by the legacy component, it is received through one serial port, forwarded to the printer or other serial device through the other serial

2. Capturing data using ODBC—The data is captured the computer where the legacy system database is stored. This computer may be the networked system server or may be a different computer where the legacy system software is installed, in which case the computer must have an Ethernet connection. The networked system periodically scans the legacy database using the ODBC driver. New data detected by the networked system that has been stored in the legacy database is sent to the networked system server. If the computer is the networked system server, the data is sent using inter-process communication, otherwise the data us sent through the Ethernet connection.

The networked system's data capture programs maintain a log file where all activity is recorded. The data capture programs can be configured to use any serial ports, to connect to any server address, and to keep log files within a specified size limit. The data capture programs continuously monitor the serial and Ethernet connections, and provide a visual indication of the status of each connection.

Data is sent by the data capture programs to the state-of the-art system server using a TCP/IP connection over Ethernet. When the capture program is started, it sends a connection request to the server. The server continuously listens on a TCP port for connection requests from the data capture programs. When a request is received, a TCP socket connection is created linking the two computers. The TCP socket connection is kept open until either the server or data capture program is terminated.

The data are sent from the data capture program to the server as a single string of characters. The data are stored by the server in a database, along with an identification of the data capture program that sent the data, and the date and time of receipt.

In the preferred embodiment, the networked system is configured to provide a screen to report the legacy data stored on the server. The report includes the identification of the data capture program that sent the data, the date and time of receipt, and the received data. The report may be sorted and filtered by identification, by date and time, and by the data string.

If the data has a fixed structure, the networked system is configured to provide for defining this structure in the server database. For each data item in the data string, the structure definition includes the item's report sequence, the item's name, the item's start and end positions within the data string, and an indicator whether the item is a legacy device identifier. The ability to determine the legacy device identifier within the data string is key to the system responses.

When the structure of the data has been defined, the report provides two additional capabilities. First, the data may be sorted and filtered by each item within the data string. Second, the legacy device identifier in the data permits the system window to be automatically configured to display the stored images from system cameras closest to the legacy device.

Additionally, the legacy can be placed on the maps in the system window display, as described in the aforementioned applications. The system can then respond to the legacy data received by the server.

The system is configured to provide for choosing which data are to be considered alarms. This is accomplished by building a table of data item and value pairs. If data are received by the server that contain one of the data defined item and value pairs, the data are considered an alarm. If no data item and value pairs are defined, any data are considered an alarm.

The system can be configured to issue any programmed response upon receipt of an alarm from the legacy system. Responses include displaying a pop-up warning on guard system display monitors, blinking the device icon on screen maps, calling paging devices, sending e-mail messages, and placing telephone calls. Where appropriate, the response includes the identifier of the data capture program that sent the alarm, the date and time of receipt, and the data string.

In addition, the system window can be configured to automatically display the live video from cameras closest to the legacy device.

In summary, the subject invention includes the means and method for incorporating legacy systems and devices into a comprehensive building support system that may be deployed singularly or in combination to achieve the degree of monitoring and protection desired. The subject invention also permits all of the support functions to be combined in a because of use of shared components, shared wiring and shared network connectivity, as well as preservation of the investment in legacy systems. The single appliance provides all of the functions previously supplied by a plurality of dedicated purpose discrete devices.

Functional superiority over the discrete devices is also achieved because of the opportunity to integrate the various subsystems common in the devices and networked appliances. The subject invention permits legacy components and devices to be used in combination with a network-based full service, multi-media surveillance system capable of a wide range of monitoring techniques utilizing digital network architecture.

In accordance with the teachings of the subject invention, any or a plurality of distinctive legacy devices may be connected to the comprehensive, wired/wireless multimedia surveillance and monitoring system for transmitting event data, video and/or image monitoring information, audio signals and other sensor and detector data over significant distances using digital data transmission over networks such as a local area network (LAN), a wireless LAN (WLAN), a wide area network such as the Internet for other network automatic event recording, assessment and response, including dispatch of response personnel. Wired, wireless and optical appliances and sensor systems may be employed. The wireless LAN connectivity permits local distribution of sensor, audio, video and image data with relatively high bandwidth without requirement of a license and without relying on a common carrier and the fees associated therewith. The surveillance system may be interfaced with a WAN (wide area network) such as optical fiber, frame relay or the Internet for providing a worldwide, low cost surveillance system with virtually unlimited geographic application. Centralized monitoring stations have access to all of the surveillance data from various remote locations via the network or the WAN. A server provides a centralized location for data collection, alarm detection and processing, access control, auto response generation, paging, automatic e-mail generation, telephone dialing and message transmission, dispatch processing, logging functions, configuration management, and/or other specialized functions. The server may be inserted virtually anywhere in the Intranet/Internet network.

Multiple sensors and devices may be accommodated, as required. The topology of Appropriate firewalls, encryption and access codes may be set up as desired to protect unauthorized access to the system or collected data. The server based system permits a security provider to have access to the device, related sensor and surveillance data or to configure or reconfigure the system from any station on the Intranet or Internet.

Any available data stream for legacy equipment can be incorporated into the system in the same manner. Examples are HVAC control signals, lighting control signal and signals and the like. As an example, an icon could flash on a map and a camera can be activated whenever lights are turned on in a specific location.

It is also an important feature of the invention that it permits the combination of signals from a variety of previously incompatible legacy devices. For example, a fire alarm system may be from one legacy supplier and generate only an audio alarm. An access sensor or access control device may be from another supplier. Using the teachings of the present invention it is now possible to send the alarm signal and the access alert signal to a single management system for managing the information and for directing an appropriate response.

The system of the subject invention permits comprehensive monitoring of locations over great distances with sufficient performance to provide widespread use as a security surveillance device.

It is, therefore, an object and a feature of the subject invention to provide the means and method for connecting legacy devices and systems to a comprehensive, multi-media, networked surveillance system.

It is an additional object and feature of the subject invention to provide the means and method for enhancing the use of data generated by legacy devices and systems by providing the data to an interactive system.

It is a further object and feature of the subject invention to provide the means and method for generating multiple reports to desired receivers using legacy devices and systems in combination with a networked surveillance system.

It is an additional object and feature of the subject invention to provide the means and method for preserving an investment in legacy devices and systems by upgrading the

It is also an object and feature of the subject invention to provide the means and method for collecting any available legacy data from any source meeting minimum requirements and managing the data via a multi-media multifunctional surveillance system.

It is yet another object and feature of the subject invention to provide the means and method for collecting and managing data from in a single system from previously incompatible sources.

Other objects and features of the subject invention will be readily apparent from the accompanying drawings and detailed description of the preferred embodiment.

### BRIEF DESCRIPTION OF THE DRAWINGS

FIG. 1 is a system diagram for a system capturing legacy data using a legacy serial Ski output port.

FIG. 2 is a system diagram for a system capturing legacy data using a local or legacy system computer.

FIG. 3 is a system diagram for a system capturing legacy data using a legacy server or a multi-media system server.

FIG. 4 is a flow chart for the system of FIG. 1.

FIG. 5 is a flow chart for the system of FIG. 2

FIG. 6 is a flow chart for the system of FIG. 3

FIG. 7 is a flow chart for a response activity from a remote guard station in response to generation and capture of legacy data.

### DETAILED DESCRIPTION OF THE PREFERRED EMBODIMENTS

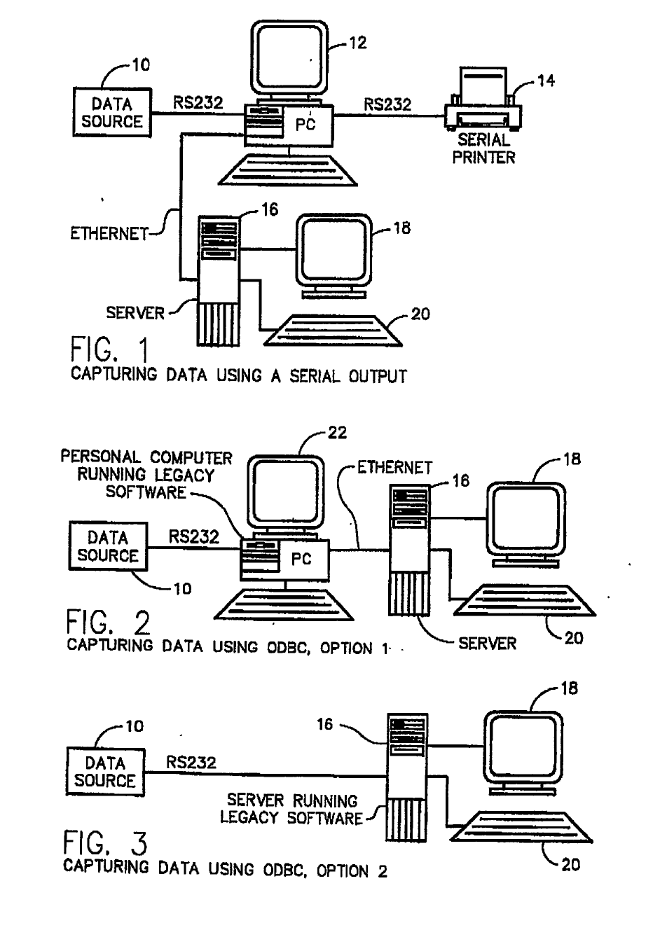

As shown in FIG. 1, a typical legacy system or device becomes a source for serial data as indicated by data source 10. This is generally output at a serial output port, or RS232 port. In the legacy configuration this is input to a legacy computer 12, or directly to a serial printer 14. In the present invention, the RS232 signal is picked off the legacy system and sent via the Ethernet to the system server 16. Once introduced into the system server, it is merged with the other appliance data in a manner permitting full functionality in accordance with the teachings of the aforementioned applications and can be displayed at monitor 18 and/or managed via various management programs or input devices such as the keyboard 20.

In a second configuration, as shown in FIG. 2, the data source 10 output on the RS232 port is input into a legacy computer 22 having a open data base connectivity (ODBC) driver. In this configuration, the ODBC Driver taps directly into the legacy database and the Ethernet connection transmits the legacy data directly to the system server 16. An alternative ODBC configuration is shown in FIG. 3. As there shown, the RS232 output from the data source 10 is connected directly to the system server 16 and the legacy software is loaded directly into the system server along with the multi-media software.

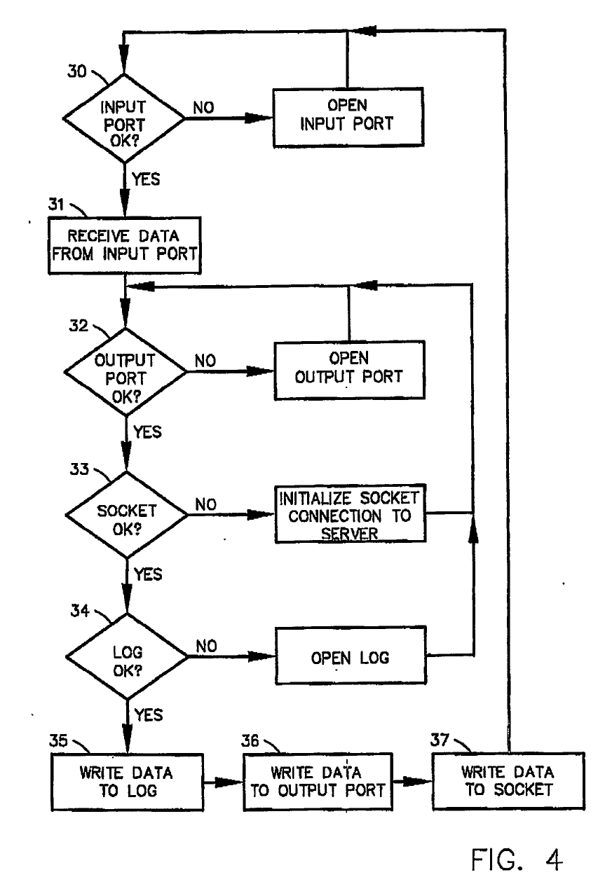

A system flow chart for the serial data capture configuration of FIG. 1 is shown in FIG. 4. Initially, the RS232 port is tested, as indicated at 30. If data is being received, as indicated at 31, the output port is then tested at 32, and the socket is tested at 33. The log is then checked (34) and the data is written (34) to the serial output port (35) and the Ethernet socket (37). The legacy system operates as before via the output port 36 and the data is transferred to the multi-media system via the socket 37. Thus, the legacy system functionality is undisturbed while greatly enhanced by using the “picked-off” data. As indicated in the flow chart, negative responses will return the loop to a suitable starting point.

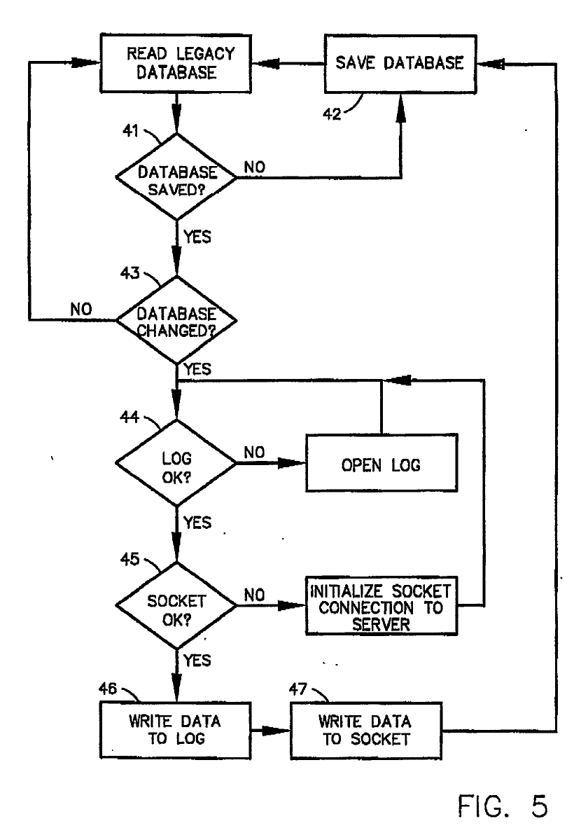

A system flow chart for the ODBC data capture configuration of FIG. 2 is shown in FIG. 5. In this configuration, the legacy database 40 is read and saved in the system server, as indicated at 41 and 42. If the data base changes (43), it is logged (44) and the socket (45) is checked for writing data to the legacy log 46 and the system socket 47. Again, negative responses provide a suitable return loop.

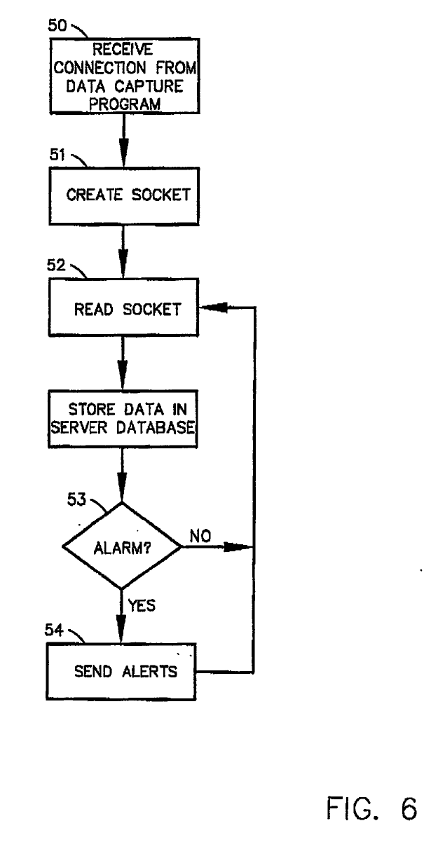

A system flow chart for the direct server configuration of FIG. 3 is shown in FIG. 6. In this configuration the device data is captured in the server as indicated at 50 and a socket 51 is created for importing the data to the multi-media system where the socket is read 52. The data is stored 53, and the legacy functions operate as previously commanded by the legacy software also loaded on the server, as indicated at 53 and 54, with appropriate loop-backs as required.

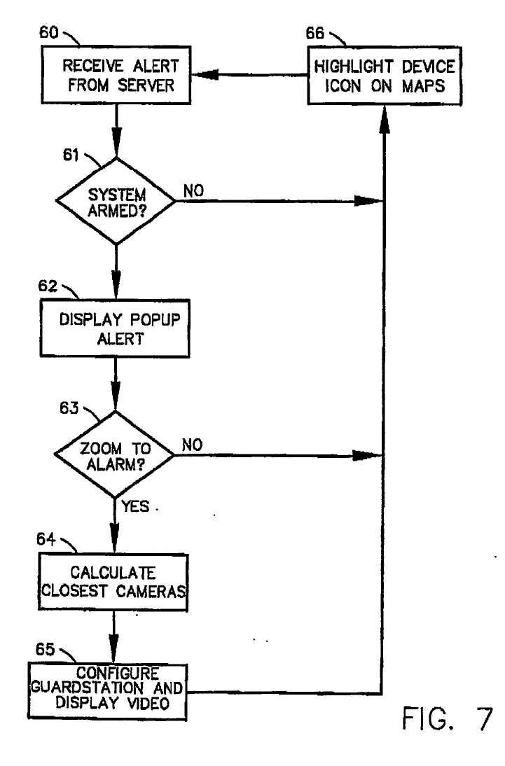

It is an important feature of the invention that the legacy data can be managed by the multi-media system to provide useful data in an interactive system. The basic flow chart for this is shown in FIG. 7. Specifically, if a legacy alert signal is received, as indicated at 60, the interactive system can use this data to perform any of the functions also associated with the multi-media system. If the system is armed (61) it is possible to provide a “pop-up” alert (62) on a guard station monitor. Other alerts can also be generated, such as an audio alert, or transmission of the signal to various remote wired and wireless stations or by e-mail or telephone transmission. Basically, any alert response available in the multi-media systems of the aforementioned applications may be activated by any legacy data signal.

In addition, other multi-media functions may respond, such as zooming (63) to the location of the alarm by using a device identifier supplied either by the legacy system or assigned by the multi-media system. One important and useful aspect of the invention is the ability to automatically activate multi-media sensors in the vicinity of the legacy device when a legacy signal is received. For example, a number of cameras trained on the vicinity of the legacy device may be activated as indicated at 64, coupled with showing the cameras on a guard station display monitor 65, and highlighting the location and activated cameras on a display monitor map as indicated at 66.

It should be noted that multiple legacy devices can connected using the teachings of the subject invention. It is desirable, but not necessary, to assign a type and location identifier to each device to maximize the enhancements provided by the multi-media interface. The type and location identifier may be supplied by the legacy system and is recognized by the multi-media system. In the alternative, the multi-media system will assign the identifier to the device.

It should also be noted that the data signals provided from the various legacy devices can be used to activate any of the available managed functions or responses of the multi-media system as described in the aforementioned applications. This permits the networked, comprehensive, multi-media surveillance system to display data collected from the legacy system through the interface. The display may be static or interactive, depending on the structure of the data. It also permits the networked system to react to the data.

Any legacy device meeting minimum requirements may be incorporated in the networked multi-media system in this manner. Specifically, in order to interface with the system the legacy device must have one of the following two features.

1. A data output to a serial printer or other serial device.

2. A database, stored on a computer, for which there is an ODBC (Open Data Base Connectivity) driver.

Data is captured from the legacy system devices in one of two ways:

1. Capturing data using a serial out—The data is captured by a PC having two serial ports and an Ethernet connection. The serial output from the legacy component is connected to one serial port, the legacy printer or other serial legacy output device is connected to the other serial port, and a network is to the Ethernet connector. When data is sent by the legacy component, it is received through one serial port, forwarded to the printer or other serial device through the other serial port, and sent to the networked system server through the Ethernet connection.

2. Capturing data using ODBC—The data is captured the computer where the legacy system database is stored. This computer may be the networked system server or may be a different computer where the legacy system software is installed, in which case the computer must have an Ethernet connection. The networked system periodically scans the legacy database using the ODBC driver. New data detected by the networked system that has been stored in the legacy database is sent to the networked system server. If the computer is the networked system server, the data is sent using inter-process communication, otherwise the data us sent through the Ethernet connection.

The means and method of the subject invention provides a novel capability to interface with legacy systems system using a one-way interface, wherein legacy data generated by the legacy system is “picked-off” and transmitted to the multi-media system without altering the legacy system function.

In the preferred embodiment of the invention, the legacy data is transmitted to the multi-media server by data capture programs using a TCP/IP connection over Ethernet. When the capture program is started, it sends a connection request to the server. The server continuously listens on a TCP port for connection requests from data capture programs. When a request is received, a TCP socket connection is created linking the legacy system and the server. The TCP socket connection is kept open until either the server or data program to the server as a single string of characters. The data are stored by the server in a database, along with an identification of the data capture program that sent the data, and the date and time of receipt.

In the preferred embodiment, the system server provides a screen to report the legacy data stored on the server. The report includes the identification of the data capture program that sent the data, the date and time of receipt, and the received data. The report may be sorted and filtered by identification, by date and time, and by the data string.

If the data has a fixed structure, multi-media system provides for defining this structure in the server database. For each data item in the data string, the structure definition includes the item's report sequence, the item's name, the item's start and end positions within the data string, and an indicator whether the item is a legacy device identifier. The ability to determine the legacy device identifier within the data string is key to the system responses.

Once the structure of the data has been defined, the report provides two additional capabilities. The data may be sorted and filtered by each item within the data string. The system window can be automatically configured to display the stored images from a selected number of cameras and other networked appliances closest to the legacy device.

The legacy devices can be placed on the maps in the system window. The system can respond to data received by the server in the same manner and with the same range of responses available to the networked devices and appliances.

In order to identify alarm-triggering data, the system builds a table of data item and value pairs. If data is received by the server that contains one of the data defined item and value pairs, the data is considered an alarm. If no data item and value pairs are defined, any data is considered an alarm. The system can be configured to issue any system response upon receipt of an alarm or an alert from a legacy device or system. Responses include displaying a pop-up warning on display monitors, blinking the device icon on maps, calling paging devices, sending e-mail messages, and placing telephone calls. Where appropriate, the response includes the identifier of the data capture program that sent the alarm, the date and time of receipt, and the data string.

In addition, the system window can be configured to automatically display the live video from system cameras closest to the legacy device.

While this description illustrates the use of the invention in connection with legacy surveillance devices, it should be understood that any available data stream for legacy equipment can be incorporated into the system in the same manner. Examples are HVAC control signals, lighting control signal and signals and the like. As an example, an icon could flash on a map and a camera can be activated whenever lights are turned on in a specific location.

It is also an important feature of the invention that it permits the combination of signals from a variety of previously incompatible legacy devices. For example, a fire alarm system may be from one legacy supplier and generate only an audio alarm. An access sensor or access control device may be from another supplier. Using the teachings of the present invention it is now possible to send the alarm signal and the access alert signal to a single management system for managing the information and for directing an appropriate response.

While certain features and embodiments have been described in detail herein, it will be understood that the invention includes all modifications and enhancements within the scope and spirit of the following claims.

What is claimed is:

1. A method for collecting legacy data from a legacy device in a non-intrusive manner and transmitting it to a comprehensive networked system, comprising the steps of:
a. reading the legacy output data generated by a legacy device;
b. transmitting the legacy output data to a system server; and
c. managing the legacy output data via the system server.

2. The method of claim 1, including the step of assigning an identifier to the legacy output data for defining the type of legacy device.

3. The method of claim 2, wherein the identifier also identifies the location of the legacy device.

4. The method of claim 1, wherein the reading step comprises reading the legacy output data on an RS232 output port of the legacy device.

5. The method of claim 1, wherein the reading step comprises reading the legacy output data on a serial output port of the legacy device.

6. The method of claim 1, wherein the legacy device includes a processor having open database connectivity and wherein the reading step comprises reading the legacy output data in the database.
